(19) United States
(12) Patent Application Publication
(10) Pub. No.: US 2025/0353324 A1
(43) Pub. Date: Nov. 20, 2025

(54) DUAL WHEEL ASSEMBLY FOR VEHICLE

(71) Applicant: MTD PRODUCTS INC, Valley City, OH (US)

(72) Inventors: Adam Hiller, Jeromesville, OH (US); Michael Gretchko, Valley City, OH (US)

(21) Appl. No.: 19/208,955

(22) Filed: May 15, 2025

Related U.S. Application Data
(60) Provisional application No. 63/648,835, filed on May 17, 2024.

(51) Int. Cl. B60B 11/02; B60B 35/12

(52) U.S. Cl. CPC B60B 11/02; B60B 35/121

(57) ABSTRACT

Provided is a dual wheel assembly for engagement with an associated vehicle having an associated chassis, the assembly having an output support and a transmission. The output support has a bell housing adapted to operationally mount to the associated chassis, and a tail shaft. The tail shaft is rotatably mounted within the bell housing, defines and is rotatable about a drive axis, and is adapted to transmit operational drive work by rotation about the drive axis. The tail shaft is further adapted to transmit and support an operational support load transverse to the drive axis. The transmission is operationally engaged to the output support and has a transmission shaft. The transmission shaft defines a transmission shaft axis, is operationally engaged with the tail shaft, and is adapted to transmit the operational drive work to the tail shaft.

### CROSS-REFERENCE TO RELATED APPLICATIONS

This application claims the benefit of U.S. Provisional Application No. 63/648,835, filed May 17, 2024, and which is hereby incorporated by reference within the present disclosure in its entirety and for all purposes.

### FIELD OF DISCLOSURE

The disclosed subject matter pertains to apparatuses and methods for powered utility vehicles. More specifically the disclosed subject matter pertains to apparatuses and methods for powered utility vehicles driving a wheel set with a transmission.

Manufacturers of vehicles for utility applications offer many types of machines. Generally, these machines can have a variety of forms depending on application, from general urban or suburban lawn maintenance, rural farm and field maintenance, to specialty applications. It is not unusual for utility vehicles to have one or more wheel sets driven by a transmission.

In some vehicles it is common to mount the wheel set to a transmission such that the transmission transmits most or all of the forces and torques between the vehicle chassis and the wheel set operationally engaged therewith. While this can provide benefits in the form of cost and manufacturability, it remains desirable to provide alternatives such that modify, reduce, minimize or eliminate, the forces and torques transmitted through the transmission between the vehicle chassis and the wheel set.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

In a first embodiment, disclosed is a dual wheel assembly for engagement with an associated vehicle having an associated chassis, the assembly having an output support and a transmission. The output support has a bell housing adapted to operationally mount to the associated chassis, and a tail shaft. The tail shaft is rotatably mounted within the bell housing, defines and is rotatable about a drive axis, and is adapted to transmit operational drive work by rotation about the drive axis. The tail shaft is further adapted to transmit and support an operational support load transverse to the drive axis. The transmission is operationally engaged to the output support and has a transmission shaft. The transmission shaft defines a transmission shaft axis, is operationally engaged with the tail shaft, and is adapted to transmit the operational drive work to the tail shaft.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 depicts a partially exploded view of a first non-limiting example of a vehicle having a transmission operationally engaged between a chassis and a wheel set.

FIG. 2 depicts a sectional view of a second non-limiting example of a vehicle having an assembly adapted for transmitting forces and torques between a chassis and a wheel set.

FIG. 3 depicts an oblique sectional view of the second non-limiting example of a vehicle having an assembly adapted for transmitting forces and torques between a chassis and a wheel set.

FIG. 4 depicts a close-up perspective view of an assembly of the second non-limiting example of a vehicle.

FIG. 5 depicts a close-up sectional perspective view of the assembly of the second non-limiting example of a vehicle.

FIG. 6 depicts a close-up sectional perspective view of the assembly of the second non-limiting example of a vehicle with some components removed.

FIG. 7 depicts a close-up perspective view of an assembly of the second non-limiting example of a vehicle.

FIG. 8 depicts a close-up perspective view of an assembly of the second non-limiting example of a vehicle with the chassis removed.

FIG. 9 depicts a close-up perspective view of an assembly of the second non-limiting example of a vehicle.

FIG. 10 depicts a close-up sectional perspective view of the assembly of the second non-limiting example of a vehicle.

FIG. 11 depicts an oblique perspective view of the second non-limiting example of a vehicle having an assembly adapted for transmitting forces and torques between a chassis and a wheel set.

FIG. 12 depicts an oblique perspective view of the second non-limiting example of a vehicle having an assembly adapted for transmitting forces and torques between a chassis and a wheel set with one wheel set shown in exploded view.

FIG. 13 depicts an oblique perspective sectional close-up view of the second non-limiting example of a vehicle with a wheel set.

FIG. 14 depicts an oblique perspective sectional close-up view of the second non-limiting example of a vehicle with a wheel set.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to a wheel assembly and vehicle with a dual wheel assembly are described herein, it should be understood that the disclosed machines, electronic apparatus and computing devices and methods are not so limited and modifications may be made without departing from the scope of the present disclosure. The scope of the machines, apparatuses, methods, and devices are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine”, “power equipment machine”, and “utility vehicle” are used interchangeably and are intended to refer to any of robotic, partially robotic ride-on, walk-behind, stand-on, sulky equipped, autonomous, semi-autonomous (e.g., user-assisted automation), remote control, or multi-function variants of any of the following: powered carts and wheelbarrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

As utilized herein, relative terms or terms of degree such as approximately, substantially, about, roughly and so forth, are intended to incorporate ranges and variations about a qualified term reasonably encountered by one of ordinary skill in the art in fabricating or compiling the embodiments disclosed herein, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic, e.g., a 0 to five-percent variance or a zero to ten-percent variance from precise mathematically defined value or characteristic (which is included in the range), or any suitable value or range there between can define a scope for a disclosed term of degree. As an example, a power equipment device can have an operating dimension, such as a heading measurement, average velocity estimate, relative position estimate, or the like, with a variance of 0 to five percent or 0 to ten percent. As another example, a disclosed mechanical dimension can have a variance of suitable manufacturing tolerances as would be understood by one of ordinary skill in the art, or a variance of a few to several percent about the disclosed mechanical dimension that would also achieve a stated purpose or function of the disclosed mechanical dimension. These or similar variances can be applicable to other contexts in which a term of degree is utilized herein such as relative position of a disclosed element, speed of a disclosed motor in rotations per minute (or other suitable metric), accuracy of measurement of a physical effect (e.g., a heading measurement, an acceleration measurement, a relative velocity, etc.) or the like. In addition to the foregoing, it should be understood that the drawings appended to this specification are not drawn to scale, unless explicitly stated in the description herein or on the drawing.

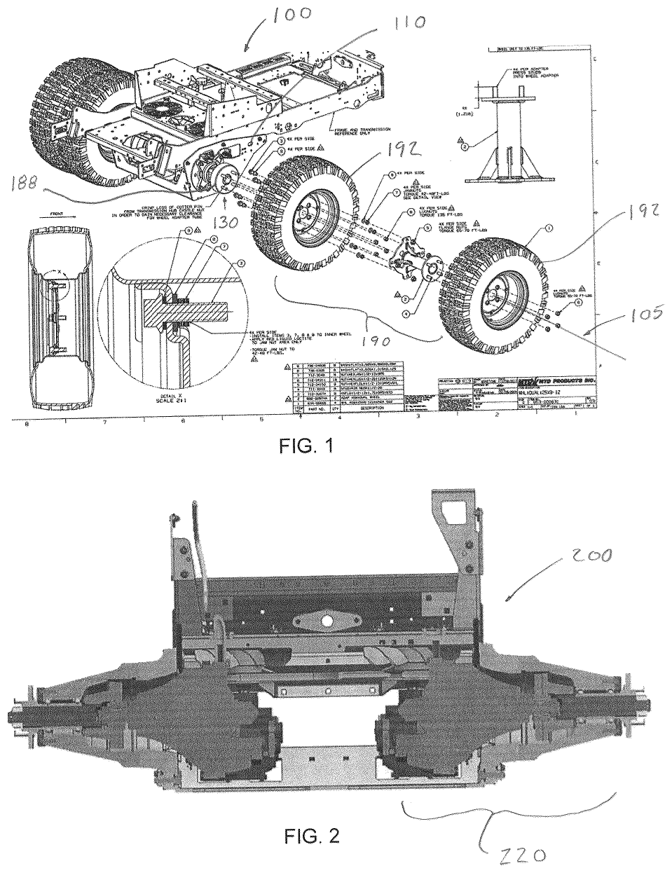

Referring now to FIG. 1 shown is a first non-limiting example of a vehicle 100 with a partially exploded view of a transmission 130 operationally engaged between a chassis 110 and a wheel set 190. The wheel set 190 shown is a dually arrangement having two tire and wheel assemblies 192 arranged for both tire and wheel assemblies 192 to be simultaneously operational engaged a single wheel hub 188. In the first non-limiting example, the transmission 130 is adapted to deliver operational torque by rotation about a drive line 105 to the wheel hub 188 and thereby to drive the engaged wheel set 190 during operation of the vehicle 100. Similarly, the transmission 130 is adapted to transmit operational loads transverse to the drive line 105 between the chassis 110 and the engaged wheel set 190 during operation of the vehicle 100. The latter operational forces may include, but are not limited to, operational support loads such as the weight of the vehicle 100 and corresponding reaction forces from the surface 90 over which the vehicle 100 is operated. The latter operational forces may include, but are not limited to, dynamic forces such as forces from acceleration, braking, or impact. It should be understood that transmission 130 may, in some non-limiting embodiments, be part of a transaxle.

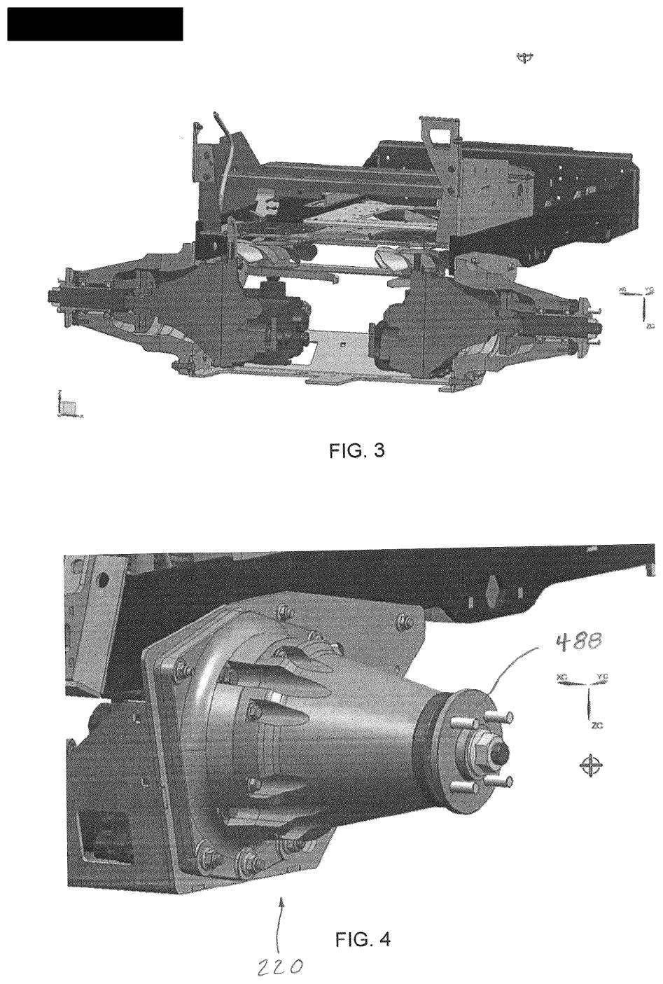

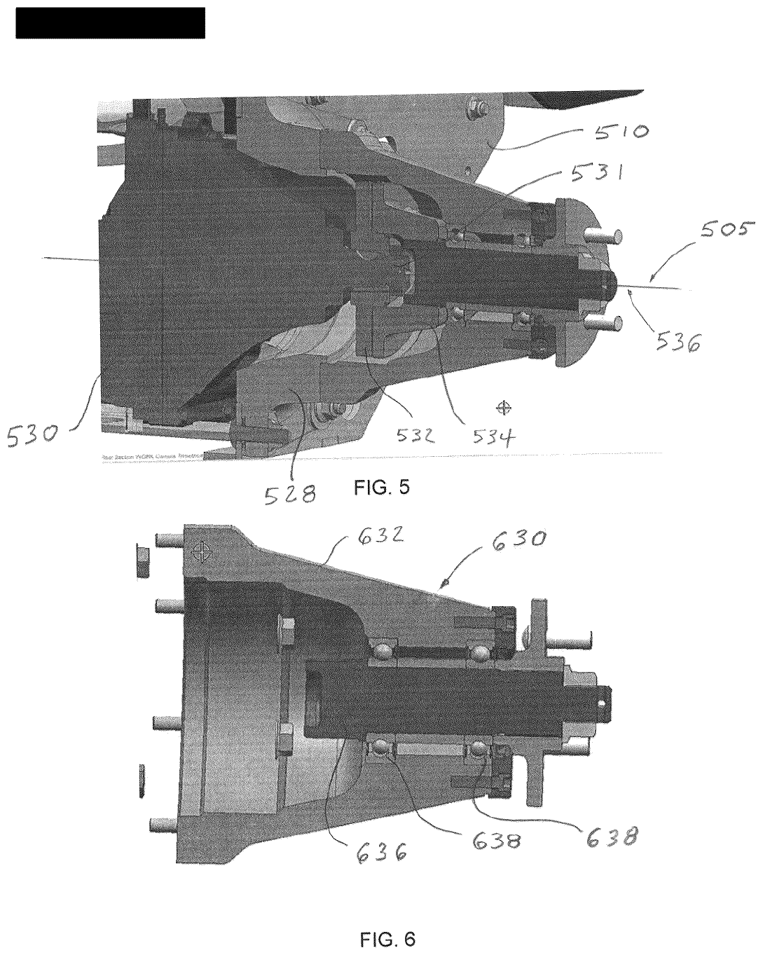

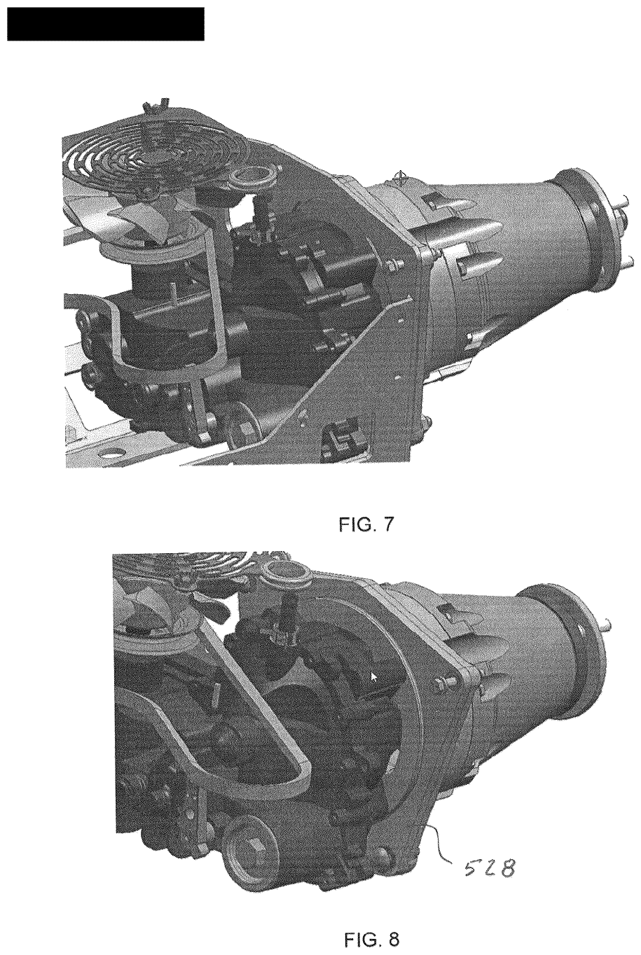

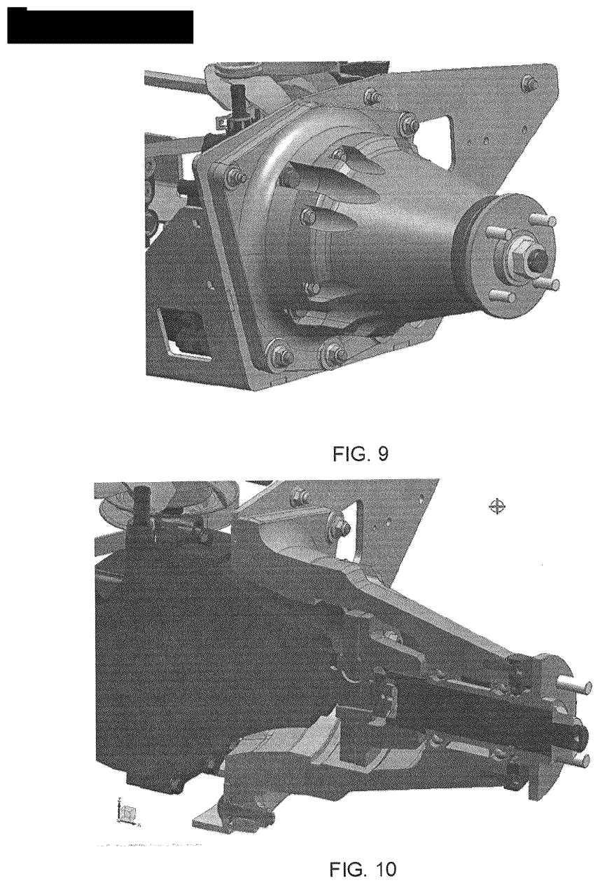

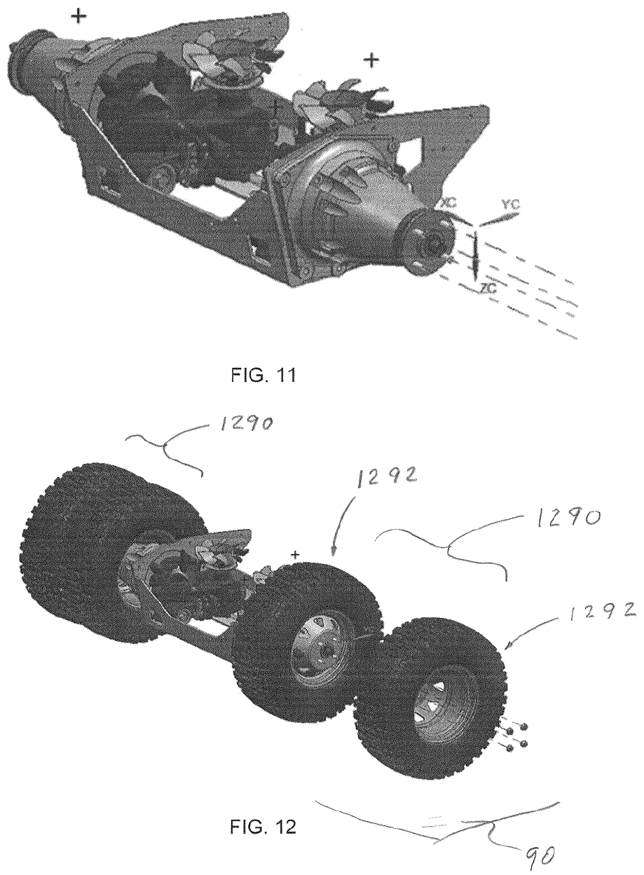

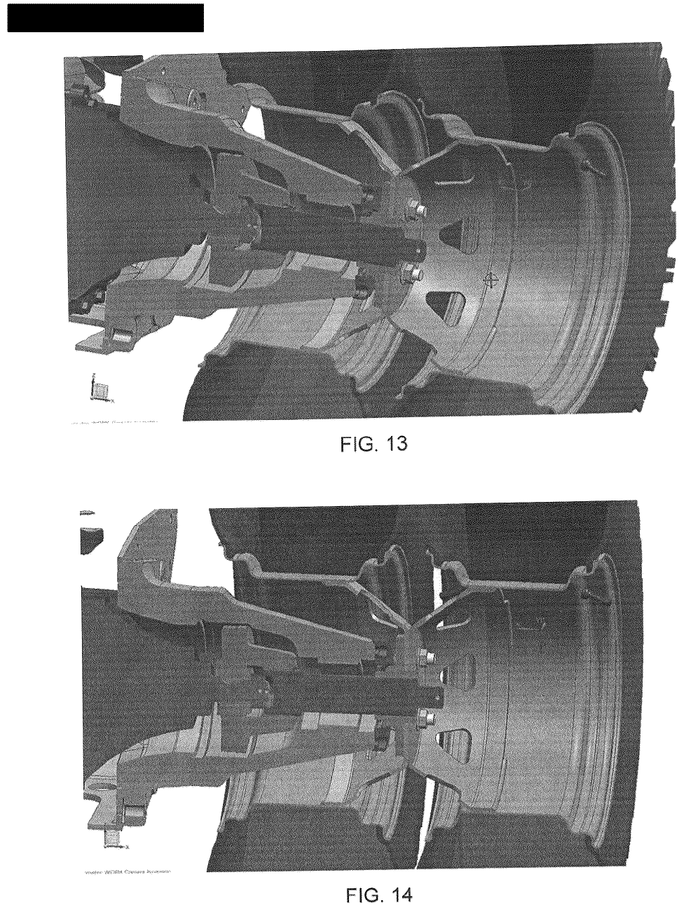

Referring now to FIGS. 2-14, shown are a plurality of views and configurations of a second non-limiting embodiment of a vehicle 200 having an assembly 220 adapted for transmitting forces and torques between a chassis 510 and a wheel set 1290. The wheel set 1290 shown is a dually arrangement having two tire and wheel assemblies 1292 arranged for both tire and wheel assemblies 1292 to be simultaneously operational engaged a single wheel hub 488. In the second non-limiting example, the transmission 530 is adapted to deliver operational torque by rotation about a drive line 505 to the wheel hub 488 and thereby to drive the engaged wheel set 1290 during operation of the vehicle 200.

Assembly 220 has an output support 630 having a bell housing 632 and a tail shaft 636. The bell housing 632 adapted to operationally mount to the chassis 510 either directly or through one or more intermediate components such as, and without limitation, adapter mount 528. The tail shaft 636 is rotatably engaged with the bell housing such as, and without limitation, through bearing 638. Tail shaft 636 defines and is rotatable about drive axis 505. Tail shaft 636 is adapted to transmit operational drive work by rotation about the drive axis 505. Also, tail shaft 636 is adapted to transmit and support operational support loads transverse to the drive axis, such as operational support loads such as the weight of the vehicle 100 and corresponding reaction forces from the surface 90 over which the vehicle 100 is operated. The tail shaft 636 may also be adapted to transmit other loads, forces, and moments, such as the dynamic loads referenced above. In some embodiments, tail shaft 636 may be rotatably mounted by a plurality of bearings 638 in order to transmit large forces, moments and loads without undesirable stress, strain, or wear. In the second non-limiting embodiment, the tail shaft 636 may be operationally engaged to wheel hub 488 directly as shown, but this is not limiting, and it is contemplated that in other embodiments, the tail shaft 636 may be operationally engaged to the wheel hub 488 though one or more additional elements such as a torque limiter, a shear pin, a clutch, or otherwise as chosen with good engineering judgment. In the second non-limiting embodiment, the tail shaft 636 may be operationally engaged to a transmission shaft 531 of transmission 530 through a transmission hub 532 connected to the transmission shaft 531 and bolted to coupler 534 as shown, but this is not limiting, and it is contemplated that in other embodiments, the tail shaft 636 may be operationally engaged to the transmission 530 through other means chosen with good engineering judgment. In the non-limiting embodiment shown, transmission hub 532 is engaged with coupler 534 by bolting, but this is not limiting. In the second non-limiting embodiment, the coupler 534 is spline connected to the tail shaft 636, but this is not limiting.

The transmission 530 is operationally engaged to the output support 630. This latter operational engagement may be direct engagement or engagement through one or more intermediate components such as, and without limitation, adapter mount 528. As referenced above, the transmission comprises a transmission shaft 531. This transmission shaft 531 is adapted to output shaft work from the transmission 530 and defines a transmission shaft axis 536 about which the transmission shaft 531 rotates as it transmits operational drive work to the tail shaft 636. In the embodiment shown in FIGS. 2-14, the transmission shaft axis 536 is coaxial with the drive axis 505 but this is not limiting and embodiments in which they are parallel and offset from one another, co-planar but not parallel, or skew are also contemplated.

Unlike in the first embodiment, in the second embodiment, the transmission 530 may be substantially isolated from operational forces transverse to the drive line 105 and transmitted at least partially along the drive axis 505 between the chassis 510 and the engaged wheel set 1290 during operation of the vehicle 200. While the transmission 530 may experience some dynamic loading, such as and without limitation, by virtue of its own mass accelerating, in this second embodiment the operational forces transverse to the drive line 505 may be transmitted between the wheel set 1290 and the chassis 510 through a path including the tail shaft 636 and the bell housing 632. It is to be understood that the latter path may in some embodiments include the wheel hub 488, the adapter mount 528, or both, but-unlike in the first embodiment—the transmission 530 need not be part of that latter path and thereby can be at least partially isolated from the transmitted forces transverse to the drive line 105.

It should be understood that transmission 530 may, in some non-limiting embodiments, be part of a transaxle. It should be further understood that the present subject matter is not limited to methods and apparatus comprising a transmission and/or transaxle. It is contemplated that in some aspects of the present subject matter, the transmission 530 or transaxle may be replaced or augmented by a wheel motor.

Referring now to FIGS. 2-5, the adapter mount 528 provides an optional operational engagement to the chassis 510. In the figures, the adapter mount 528 is shown directly engaged to the chassis 510 but indirect engagement through one or more intermediate components is also contemplated. In the latter figures, the output support 630 is shown engaged to the adapter mount 532 which is engaged to the chassis 510, in each case by bolting: this is not limiting and other engagement means chosen with good engineering judgment are contemplated. In the latter figures, the transmission 530 is shown engaged to the adapter mount 532 which is engaged to the chassis 510, in each case by bolting: this is not limiting and other engagement means chosen with good engineering judgment are contemplated.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments may include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A dual wheel assembly for engagement with an associated vehicle having an associated chassis, the assembly comprising:
an output support having
a bell housing adapted to operationally mount to the associated chassis, and
a tail shaft rotatably mounted within the bell housing,
the tail shaft defining and being rotatable about a drive axis,
the tail shaft being adapted to transmit operational drive work by rotation about the drive axis,
the tail shaft being adapted to transmit and support an operational support load transverse to the drive axis;
a transmission operationally engaged to the output support, the transmission having transmission shaft, the transmission shaft
defining a transmission shaft axis,
being operationally engaged with the tail shaft, and
adapted to transmit the operational drive work to the tail shaft.

2. The dual wheel assembly for engagement with an associated vehicle having an associated chassis of claim 1, wherein the transmission is part of a transaxle.

3. The dual wheel assembly for engagement with an associated vehicle having an associated chassis of claim 1, wherein the output support is engaged to an adapter mount wherein the adapter mount is adapted to operationally mount to the associated chassis.

4. The dual wheel assembly for engagement with an associated vehicle having an associated chassis of claim 3, wherein the transmission is engaged to the output support through the adapter mount.

5. The dual wheel assembly for engagement with an associated vehicle having an associated chassis of claim 4, wherein the transmission is part of a transaxle.

6. The dual wheel assembly for engagement with an associated vehicle having an associated chassis of claim 1, wherein the transmission shaft axis is coaxial with the drive axis.

7. The dual wheel assembly for engagement with an associated vehicle having an associated chassis of claim 1, wherein the tail shaft is operationally engaged to a wheel hub adapted to operationally mount a wheel set.

8. A vehicle comprising
a chassis;
a dual wheel assembly having
an output support having
a bell housing operationally engaged to the associated chassis, and
a tail shaft rotatably mounted within the bell housing,
the tail shaft defining and being rotatable about a drive axis,
the tail shaft being adapted to transmit an operational drive work by rotation about the drive axis,
the tail shaft being adapted to transmit and support an operational support load transverse to the drive axis,
a transmission operationally engaged to the output support, the transmission having a transmission shaft, the transmission shaft
defining a transmission shaft axis,
being operationally engaged with the tail shaft, and
adapted to transmit operational drive work to the tail shaft, and
a wheel hub
operationally engaged to the tail shaft, and
adapted to operationally mount one or more associated wheels thereto;
a wheel set
operationally engaged to the wheel hub, and
adapted to support the vehicle while operational motion.

9. The vehicle of claim 8, wherein the transmission is part of a transaxle.

10. The vehicle of claim 8, wherein the output support is engaged to an adapter mount.

11. The vehicle of claim 10, wherein the adapter mount is operationally mounted to the chassis.

12. The vehicle of claim 11, wherein the transmission is engaged to the output support through the adapter mount.

13. The vehicle of claim 12, wherein the transmission is part of a transaxle.

14. The vehicle of claim 8, wherein the transmission shaft axis is coaxial with the drive axis.

15. The vehicle of claim 8, wherein the tail shaft is operationally engaged to a wheel hub adapted to operationally mount a wheel set.

16. A vehicle comprising
a chassis;
adapter mount operationally engaged to the chassis; and
a dual wheel assembly having
an output support having
a bell housing operationally mounted to the adapter mount, and
a tail shaft rotatably mounted within the bell housing,
the tail shaft defining and being rotatable about a drive axis,
the tail shaft being adapted to transmit an operational drive work by rotation about the drive axis,
the tail shaft being adapted to transmit and support an operational support load transverse to the drive axis,
a transmission operationally engaged to the adapter mount, the transmission having a transmission shaft, the transmission shaft
defining a transmission shaft axis,
being operationally engaged with the tail shaft through a transmission hub and a coupler,
adapted to transmit operational drive work to the tail shaft, and
a wheel hub
operationally engaged to the tail shaft, and
adapted to operationally mount one or more associated wheels thereto.

17. The vehicle of claim 16, further comprising a wheel set operationally engaged to the wheel hub, and adapted to support the vehicle while in operational motion.

18. The vehicle of claim 17, wherein the wheel set is a dually arrangement having two tire and wheel assemblies simultaneously operationally engaged to the wheel hub.
